(19) United States
(12) Patent Application Publication
(10) Pub. No.: US 2026/0234347 A1
(43) Pub. Date: Aug. 13, 2026

(54) SYSTEMS AND METHODS FOR MAKING GLYOXALATED POLYACRYLAMIDE (GPAM) RESIN

(71) Applicant: SOLENIS TECHNOLOGIES, L.P., Wilmington, DE (US)

(72) Inventors: Logan Shoop, Durham, NC (US); Dominick Scialabba, Durham, NC (US); John Baron, Salisbury, CT (US)

(73) Assignee: SOLENIS TECHNOLOGIES, L.P., Wilmington, DE (US)

(21) Appl. No.: 19/534,825

(22) Filed: Feb. 10, 2026

Related U.S. Application Data
(60) Provisional application No. 63/756,974, filed on Feb. 11, 2025.

(51) Int. Cl. C08J 3/24; C08K 5/07

(52) U.S. Cl. CPC C08J 3/248; C08K 5/07; C08J 2333/26

(57) ABSTRACT

Methods, systems, and production units are provided for producing glyoxalated polyacrylamide (gPAM). A modular on-site production unit for producing glyoxalated polyacrylamide (gPAM) includes an air driven pump configured to provide energy for mixing, adding water, chemicals and transferring a product; and eductors configured to convey hazardous chemicals using energy provided from water pressure, wherein the hazardous chemicals are conveyed at less than atmospheric pressure, wherein control functions use only 12 to 24 volts direct current (VDC).

### CROSS REFERENCES TO RELATED APPLICATION

This application claims priority to U.S. Provisional Patent Application No. 63/756,974, filed Feb. 11, 2025, the entire content of which is incorporated by reference herein.

### TECHNICAL FIELD

The present disclosure relates generally to additive compounds and compositions for papermaking and, more specifically, to methods and systems for making glyoxalated polyacrylamide (gPAM) resins.

### BACKGROUND

Papermaking is a complex process in which paper is prepared from pulp (e.g., wood), water, filler, and various chemicals. Paper manufacturing is among the most water intensive industries, as the processes include numerous stages reliant on substantial amounts of water and aqueous solutions being added to the cellulosic fibers (i.e., the “inflow stream”) to give a furnish, and eventually separated from the furnish (i.e., the “effluent stream”) to give the final product. In the course of a typical papermaking process, a relatively concentrated aqueous slurry of cellulosic material (i.e., “thick stock”) is diluted by addition of water to give a relatively diluted slurry of cellulosic material (i.e., “thin stock”), which is used to prepare a paper web that must be dewatered to give the final product. Throughout the papermaking process, various chemical additives are employed to improve particular properties of the process (i.e., “process aids”) and/or the final product being prepared (i.e., “functional aids”). Examples of processes aids include defoamers and antifoams, retention aids, biocides, drainage aids, formation aids, etc. Examples of functional additives include strength aids, e.g., for imparting temporary wet-strength (TWS), wet-strength (WS), and/or dry-strength (DS) to the final product.

In view of the number and complexity of required stages in a given papermaking process, and the number and amounts of additives utilized in each stage, there is increasing demand for additives that provide both process and functional improvements to a given processes. Unfortunately, however, achieving some sought after improvements may lead to a decrease in other performance factors. For example, achieving high retention, which can lead to improvements in the strength of the final product, can lead to reduced drainage and formation. Using conventional high molecular weight drainage aids can provide excellent drainage and retention, but offer little to no strength benefits, and in some instances even result in a reduced strength due to overflocculation. Certain DS aids like polyamidoepichlorohydrins (PAE) can give excellent dry strength, but offer little to no drainage benefits and have limited repulpability. Complicating matters further, the efficiency of any given solution is strongly furnish dependent, with some of the best known dry strength and/or drainage aids failing under desired conditions, e.g., due to fines content, lignin content, and/or conductivity of the furnish system. As such, while there are programs to address these furnish derived performance reductions, there is a still present need for additives that provide exceptional dewatering and good dry strength in even the most challenging furnish systems.

One category of chemicals being increasingly explored for multi-use additive application includes glyoxalated polyacrylamide (gPAM) resins, which have been utilized in the paper industry for many years as processes aids, e.g. for improving water drainage during the papermaking process, and also as functional additives, e.g. for imparting temporary wet-strength (TWS), wet-strength (WS), and dry-strength (DS) to the final paper(s) being prepared. Typical gPAM resins are prepared by glyoxalating polyacrylamides (PAM), i.e., by reacting glyoxal with a PAM or PAM copolymer, such as those prepared from acrylamide (AM) and various anionic or cationic monomers.

Accordingly, it would be desirable to develop reliable, high-performance systems and methods for safely making gPAM resins onsite to avoid storage and transportation costs. Furthermore, other desirable features and characteristics of embodiments will become apparent from the subsequent detailed description and the appended claims, taken in conjunction with the accompanying drawings and the foregoing technical field and background.

### BRIEF SUMMARY

This summary is provided to introduce a selection of concepts in a simplified form that are further described below in the detailed description section.

In an embodiment, a modular on-site production unit for producing glyoxalated polyacrylamide (gPAM) includes an air driven pump configured to provide energy for mixing, adding water, chemicals and transferring a product; and eductors configured to convey hazardous chemicals using energy provided from water pressure, wherein the hazardous chemicals are conveyed at less than atmospheric pressure, wherein control functions use only 12 to 24 volts direct current (VDC).

In certain embodiments of the production unit, the air driven pump is in selective communication with a polyacrylamide source and configured to pump polyacrylamide to a reaction tank in a first mode of operation, to re-circulate contents of the reaction tank in a second mode of operation, and to remove a product including the glyoxalated polyacrylamide (gPAM) from the reaction tank in a third mode of operation.

In certain embodiments, the production unit further includes a reaction tank; a controller; and a pH sensor configured to monitor pH within the reaction tank and to communicate a pH signal to the controller; and the controller is configured to determine whether to add caustic to the reaction tank based on the pH.

In certain embodiments, the production unit further includes a reaction tank; a controller; and a turbidity sensor configured to monitor a turbidity within the reaction tank and to communicate a turbidity signal to the controller; and the controller is configured to determine whether to add acid to the reaction tank based on the turbidity.

In certain embodiments of the production unit, the eductors include a first water-actuated eductor in selective communication with a water source and a glyoxal source and configured to form a mixture of glyoxal and water and to feed the mixture of glyoxal and water to a reaction tank; and a second water-actuated eductor in selective communication with the water source and a caustic source and configured to form a mixture of caustic and water and to feed the mixture of caustic and water to the reaction tank to increase a pH therein to a threshold pH at which a crosslinking reaction forms the glyoxalated polyacrylamide (gPAM).

In certain embodiments of the production unit, the air driven pump is in selective communication with a polyacrylamide source and configured to pump polyacrylamide to the reaction tank in a first mode of operation, to re-circulate contents of the reaction tank in a second mode of operation, and to remove a product including the glyoxalated polyacrylamide (gPAM) from the reaction tank in a third mode of operation.

In certain embodiments, the production unit further includes a third water-actuated eductor in selective communication with the water source and an acid source and configured to form a mixture of acid and water and to feed the mixture of acid and water to the reaction tank to decrease the pH therein to quench the crosslinking reaction.

In certain embodiments, the production unit further includes a first air-actuated valve configured to feed glyoxal to the first water-actuated eductor; a second air-actuated valve configured to feed caustic to the second water-actuated eductor; and a third air-actuated valve configured to feed acid to the third water-actuated eductor.

In certain embodiments, the production unit further includes a controller; a pH sensor configured to monitor pH within the reaction tank and to communicate a pH signal to the controller; and a turbidity sensor configured to monitor a turbidity within the reaction tank and to communicate a turbidity signal to the controller; wherein the controller is configured to determine whether to add caustic to the reaction tank based on the pH, and to automatically operate the second air-actuated valve to add caustic to the reaction tank, and wherein the controller is configured to determine whether to add acid to the reaction tank based on the turbidity, and to automatically operate the third air-actuated valve to add acid to the reaction tank.

In another embodiment, a low voltage system is provided for making glyoxalated polyacrylamide (gPAM). The system includes a reaction tank; a first water-actuated eductor in selective communication with a water source and a glyoxal source and configured to form a mixture of glyoxal and water and to feed the mixture of glyoxal and water to the reaction tank; a second water-actuated eductor in selective communication with the water source and a caustic source and configured to form a mixture of caustic and water and to feed the mixture of caustic and water to the reaction tank to increase a pH therein to a threshold pH at which a crosslinking reaction forms glyoxalated polyacrylamide (gPAM); and an air-operated pump in selective communication with a polyacrylamide source and configured to pump polyacrylamide to the reaction tank in a first mode of operation, to re-circulate contents of the reaction tank in a second mode of operation, and to remove a product including the glyoxalated polyacrylamide (gPAM) from the reaction tank in a third mode of operation.

In certain embodiments of the system, the system operates without using a voltage greater than 24 volts. calculate a quantity of polyacrylamide fed to the reaction tank based on the second flow rate signal.

In certain embodiments, the system further includes a third water-actuated eductor in selective communication with the water source and an acid source and configured to form a mixture of acid and water and to feed the mixture of acid and water to the reaction tank to decrease the pH therein to quench the crosslinking reaction; a first air-actuated valve configured to feed glyoxal to the first water-actuated eductor; a second air-actuated valve configured to feed caustic to the second water-actuated eductor; a third air-actuated valve configured to feed acid to the third water-actuated eductor; a controller; a pH sensor configured to monitor pH within the reaction tank and to communicate a pH signal to the controller; a turbidity sensor configured to monitor a turbidity within the reaction tank and to communicate a turbidity signal to the controller; a first flow sensor for monitoring a flow rate of glyoxal to the first water-actuated eductor and for communicating a first flow rate signal to the controller; a second flow sensor for monitoring a flow rate of polyacrylamide to the reaction tank and for communicating a second flow rate signal to the controller, a drain line; a fifth air-actuated valve configured to selectively open fluid communication between the drain line and the air-operated pump to empty the reaction tank, wherein the air-operated pump is configured to pump the contents of the reaction tank to the drain line in a fourth mode of operation; a bulk tank; and a sixth air-actuated valve configured to selectively open fluid communication between the bulk tank and the air-operated pump to pump the product including glyoxalated polyacrylamide (gPAM) to the bulk tank in the third mode of operation; wherein the controller is configured to determine whether to add caustic to the reaction tank based on the pH, and to automatically operate the second air-actuated valve to add caustic to the reaction tank; determine whether to add acid to the reaction tank based on the turbidity, and to automatically operate the third air-actuated valve to add acid to the reaction tank; automatically operate the air-operated pump to pump the polyacrylamide to the reaction tank in the first mode of operation; automatically operate the air-operated pump to pump to re-circulate the contents of the reaction tank in the second mode of operation; automatically operate the air-operated pump to remove the product including glyoxalated polyacrylamide (gPAM) from the reaction tank in the third mode of operation; calculate a quantity of glyoxal fed to the reaction tank based on the first flow rate signal; and

In another embodiment, a low voltage method for making glyoxalated polyacrylamide (gPAM) includes feeding glyoxal and water into a tank; operating an air-operated pump in a first mode to feed a polyacrylamide to the tank; feeding caustic into the tank to increase a pH therein to a threshold pH at which a crosslinking reaction forms the glyoxalated polyacrylamide (gPAM); operating the air-operated pump in a second mode to re-circulate contents of the tank with the air-operated pump; and after quenching the crosslinking reaction, operating the air-operated pump in a third mode to remove a product including the glyoxalated polyacrylamide (gPAM) from the tank.

In certain embodiments of the method, the method is performed without using a voltage greater than 24 volts.

In certain embodiments, the method further includes forming a mixture of glyoxal and water with a first water-actuated eductor, wherein feeding the glyoxal and water into the tank includes feeding the mixture of glyoxal and water into the tank.

In certain embodiments, the method further includes forming a mixture of caustic and water with a second water-actuated eductor, wherein feeding the caustic into the tank includes feeding the mixture of caustic and water into the tank.

In certain embodiments, the method further includes forming a mixture of acid and water with a third water-actuated eductor; and feeding the mixture of acid and water to the tank to decrease the pH therein to quench the crosslinking reaction.

In certain embodiments, the method further includes operating a first air-actuated valve to feed glyoxal to the first water-actuated eductor; operating a second air-actuated valve to feed caustic to the second water-actuated eductor; and operating a third air-actuated valve to feed acid to a third water-actuated eductor.

In certain embodiments, the method further includes monitoring a pH within the tank with a pH sensor; communicating the pH to a controller; determining with the controller whether to add caustic to the tank based on the pH; and automatically operating the second air-actuated valve with the controller to add caustic to the tank.

In certain embodiments, the method further includes monitoring a turbidity within the tank with a turbidity sensor; communicating the turbidity to the controller; determining with the controller whether to add acid to the tank based on the turbidity; and automatically operating the third air-actuated valve with the controller to add acid to the tank.

### BRIEF DESCRIPTION OF THE DRAWINGS

A more complete understanding of the subject matter may be derived from the following detailed description taken in conjunction with the accompanying drawing, wherein:

FIGS. 1-4 are schematic views of a system for making glyoxalated polyacrylamide (gPAM) resins in accordance with various embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the systems and methods defined by the claims. Furthermore, there is no intention to be bound by any expressed or implied theory presented in the preceding Technical Field, Background, Brief Summary or the following Detailed Description. For the sake of brevity, conventional techniques and compositions may not be described in detail herein.

Embodiments of the present disclosure relate to the production of glyoxalated polyacrylamide (gPAM), a strength aid used in the paper industry.

More specifically, embodiments herein provide a low cost system with improved safety features for producing gPAM. For example, systems herein are operated on an electricity supply of 24 volts or lower, i.e., non-lethal voltages, and do not require voltages of greater than 24 volts, such as 120 or 240 volt systems.

In certain embodiments, all of the valves of the system are air-operated or low-voltage operated, i.e., at 24 volts or less.

In systems described herein, compressed air provided from an external source is used as an energy source for operation. The compressed air source may be at a safe pressure of from 60 to 150 psig. In systems described herein, energy for the operation of the system comes from a single air-driven pump.

In certain embodiments, systems described herein may be maintained by a non-electrician because no dangerous voltages are present, unlike conventional systems that require maintenance by licensed electricians. Further, service of systems described herein may require relatively little time. As a result, minimal lockout, i.e., non-operation time, is required for most components.

In addition to their safety and low cost, systems described herein also utilize relatively little space. For example, a footprint of a system according to embodiment herein may require only twenty (20) square feet, as compared to conventional systems that use about 150 square feet.

GPAM may include a polyacrylamide backbone that has been modified to contain charged monomers (often cationic). This modified polyacrylamide backbone is reacted with glyoxal, a crosslinker used to build branching and increase molecular weight. The resulting gPAM is used in the papermaking process to increase bonding between fibers and enhance strength, typically through wet end addition or sprayed onto the formed paper sheet. GPAM can also increase paper machine efficiency through enhanced press dewatering.

In certain embodiments, the method for making gPAM includes feeding water, glyoxal, and cationic polyacrylamide (CPAM) to a reaction chamber to form a mixture, and increasing the pH of the mixture to instigate a crosslinking reaction between the glyoxal and the cationic polyacrylamide (CPAM). Specifically, caustic such as sodium hydroxide is added to the reaction chamber to increase the pH. In certain embodiments, the pH is raised to from pH 9.5 to pH 11.

In embodiments herein, crosslinking is carried out until the desired molecular weight of the GPAM has been reached. The molecular weight needs to be high enough to facilitate fiber/fiber bonding, but not so high that it causes excessive flocculation and poor sheet formation, which can lower strength. In certain embodiments wherein, the reaction endpoint is determined by turbidity. Turbidity of the reaction product may be measured by a turbidimeter. In certain embodiments, the turbidimeter is a continuous-monitoring instrument designed for measuring turbidity in fluids. The instrument design is based on the nephelometric principle, where light scattered by particles suspended in the fluid is measured to determine the relative amount of particulate matter in the fluid. In certain embodiments, the desired turbidity, indicating that the GPAM has the desired appropriate molecular weight, is from zero to 200 Formazin Nephelometric Units (FNU).

When the desired turbidity threshold or range is reached, the crosslinking reaction is quenched by decreasing the pH of the mixture. Specifically, acid such as sulfuric acid is added to the reaction chamber to decrease the pH. Typically, the pH is lowered to less than about pH 6, such as less than pH 3. The use of a strong acid such as sulfuric acid can pose various safety risks, especially when used on a manufacturing scale. Therefore, the system herein is provided with safety mechanisms to prevent acid leaks or spills.

Despite the quenching process that is used to manufacture GPAMs, latent crosslinking can still occur and, over time, will cause the polymer solution to gel and be unusable. This results in a short shelf-life for the product (15-45 days at room temperature). Heat increases the crosslinking reaction, shortening the shelf-life further in warm climates. To prolong shelf-life, the polymer solids of GPAM solutions are often kept very low (less than 10%). There are then significant disadvantages to GPAMs produced off-site at chemical plants; due to the low solids, high volumes of the product are needed to meet the needs of the papermaker. The short shelf-life also increases the complexity of chemical logistics and storage at the customer site. Safety is also a concern due to the high volumes of chemical that need to be handled by mill personnel. There are also drawbacks from a sustainability standpoint, in that the vast majority of the product being transported is water (over 90% by weight). Embodiment herein may meet the need for a system and process of generating GPAM onsite that eliminates or greatly reduces such issues.

In some embodiments, GPAM may be prepared by combining glyoxal, water and a polyacrylamide, such as cationic polyacrylamide (CPAM), in a reaction vessel (such as a tank) to obtain a reaction mixture. The pH in the reaction vessel is raised by adding caustic until a threshold pH is reached. When the threshold pH is reached, a crosslinking reaction occurs, forming the GPAM. When a threshold turbidity is reached, the reaction is quenched by adding acid to the tank.

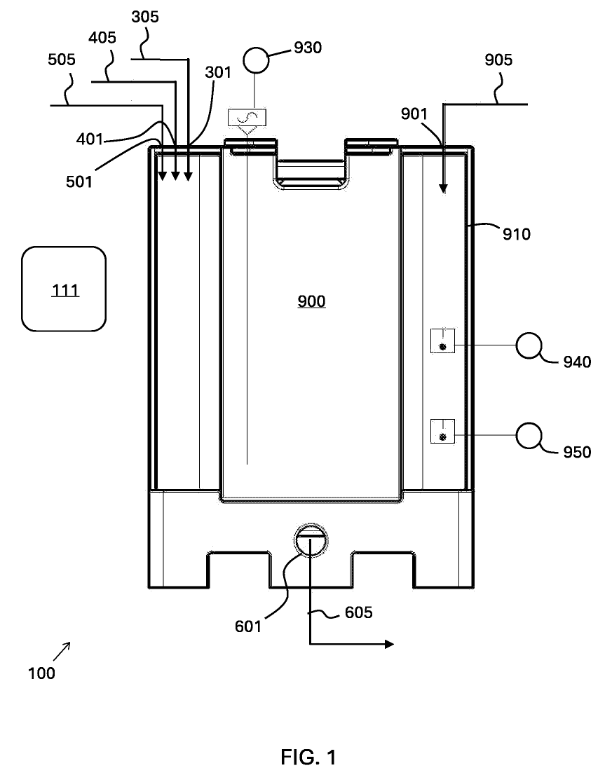

FIGS. 1-3 schematically illustrate a system 100 for making glyoxalated polyacrylamide (GPAM).

As shown in FIG. 1, the system 100 includes a controller 111 or control module 111. As used herein, the term module refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

As shown in FIG. 1, the system 100 further includes a tank or reaction vessel 900 formed by chamber walls 910. In certain embodiments, the controller 111 may be located on or in structural connection with the tank 900. In certain embodiments, certain components of the controller 111 may be located on or in structural connection with the tank 900. In certain embodiments, the controller 111, or certain components of the controller 111, may be located remote from the tank 900.

As shown in FIG. 1, the tank 900 includes an inlet 301 through the chamber wall 910 for receiving glyoxal through glyoxal feed line 305. More specifically, water and glyoxal are received from glyoxal feed line 305. The tank 900 further includes an inlet 401 through the chamber wall 910 for receiving acid through acid feed line 405. More specifically, water and acid are received from acid feed line 405. The tank 900 also includes an inlet 501 through the chamber wall 910 for receiving caustic through caustic feed line 505. More specifically, water and caustic are received from caustic feed line 505.

As shown, the tank 900 also includes an inlet 901 through the chamber wall 910 for receiving polyacrylamide through polyacrylamide feed line 905. Further, the tank 900 includes an outlet 601 through the chamber wall 910 through which a GPAM product may be removed from the tank 900 via a product output line 605.

As shown, the tank 900 may be provided with sensors to monitor conditions within the tank 900. For example, the tank 900 may include a reaction vessel level indicator 930 to monitor and measure the fluid level inside the tank 900. Further, the tank 900 may include a pH sensor 940, such as a digitally guarded pH probe. Also, the tank 900 may include a turbidity sensor 950, such as a threaded connection turbidity probe. Each sensor 930, 940, and 950 may be in electronic communication with the controller 111, such as by wired or wireless connection.

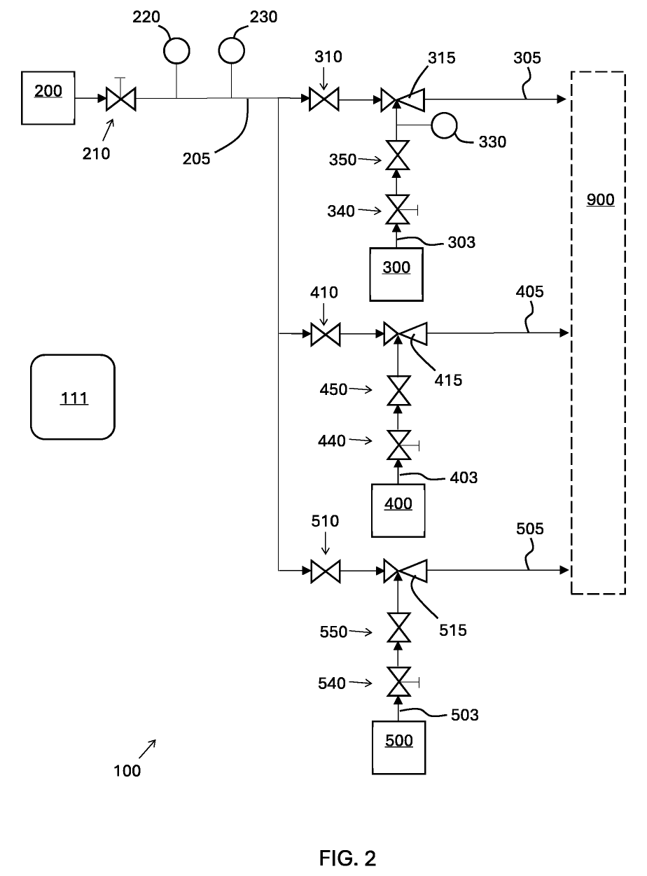

FIG. 2 schematically illustrates the feed lines 305, 405, and 505 of system 100. Glyoxal feed line 305 received glyoxal from a glyoxal source 300, acid feed line 405 receives acid from an acid source 400, and caustic feed line 505 receives caustic from a caustic source 500. As shown in FIG. 2, each feed line 305, 405, 505, is selectively fed by a water source 200. Water is provided in a water feed line 205 from source 200 at a typical pressure, such as at the pressure supplied by a municipal source. As shown, a shut-off valve 210 is provided on water feed line 205. The shut-off valve 210 may be manually operated, or in certain embodiments may be controlled by system controller 111.

As shown in FIG. 2, system 100 includes sensors on water line 205. Specifically, water line 205 may be provided with a pressure sensor 220 for monitoring the pressure of the water. Also, water line 205 may be provided with a flow meter for monitoring the flow rate of the water. Each sensor 220 and 230 may be in electronic communication with the controller 111, such as by wired or wireless connection.

In FIG. 2, water line 204 is operatively connected to glyoxal feed line 305, acid feed line 405, and caustic feed line 505 through a respective valve.

For example, valve 310 may be selectively opened to allow flow of water from water feed line 205 to an eductor 315, i.e., a jet pump or venturi pump. The eductor 315 uses the fluid flow of water from water feed line 205 to move glyoxal through a glyoxal input line 303. Specifically, the eductor 315 converts the pressure energy of the water into velocity energy, which is used to pump the glyoxal through glyoxal input line 303 from glyoxal source 300. The water and the glyoxal mix in the diverging section of the eductor 315 and are discharged from the eductor 315 through an outlet to glyoxal feed line 305. Thus, a mixture of water and glyoxal is provided in the glyoxal feed line 305.

In certain embodiments, valve 310 is air-actuated. The valve 310 may be operated by the system controller 111. In certain embodiments, valve 310 is a spring valve biased to close. Thus, in the event of a loss of power, valve 310 closes to stop flow of water to eductor 315.

As shown, a shut-off valve 340 may be provided on the glyoxal input line 303. The shut-off valve 340 may be manually operated.

As further shown, a valve 350 is also provided on the glyoxal input line 303. In certain embodiments, valve 350 is air-actuated. The valve 350 may be operated by the system controller 111. In certain embodiments, valve 350 is a spring valve biased to close. Thus, in the event of a loss of power, valve 350 closes to stop flow of glyoxal through the glyoxal input line 303.

Also, a sensor 330 is provided on the glyoxal input line 303. Sensor 330 may be a flow meter for monitoring the flow rate of glyoxal in glyoxal input line 303 from the glyoxal source 300 to the eductor 315. Sensor 330 may be in electronic communication with the controller 111, such as by wired or wireless connection.

Similarly, valve 410 may be selectively opened to allow flow of water from water feed line 205 to an eductor 415, i.e., a jet pump or venturi pump. The eductor 415 uses the fluid flow of water from water feed line 205 to move acid through an acid input line 403. Specifically, the eductor 415 converts the pressure energy of the water into velocity energy, which is used to pump the acid through acid input line 403 from acid source 400. The water and the acid mix in the diverging section of the eductor 415 and are discharged from the eductor 415 through an outlet to acid feed line 405. Thus, a mixture of water and acid is provided in the acid feed line 405. In certain embodiments, the acid is sulfuric acid provided in the form of a 95 to 98% sulfuric acid aqueous solution from the acid source 400.

In certain embodiments, valve 410 is air-actuated. The valve 410 may be operated by the system controller 111. In certain embodiments, valve 410 is a spring valve biased to close. Thus, in the event of a loss of power, valve 410 closes to stop flow of water to eductor 415.

As shown, a shut-off valve 440 may be provided on the acid input line 403. The shut-off valve 440 may be manually operated.

As further shown, a valve 450 is also provided on the acid input line 403. In certain embodiments, valve 450 is air-actuated. The valve 450 may be operated by the system controller 111. In certain embodiments, valve 450 is a spring valve biased to close. Thus, in the event of a loss of power, valve 450 closes to stop flow of acid through the acid input line 403.

Further, valve 510 may be selectively opened to allow flow of water from water feed line 205 to an eductor 515, i.e., a jet pump or venturi pump. The eductor 515 uses the fluid flow of water from water feed line 205 to move caustic through a caustic input line 503. Specifically, the eductor 515 converts the pressure energy of the water into velocity energy, which is used to pump the caustic through caustic input line 503 from caustic source 500. The water and the caustic mix in the diverging section of the eductor 515 and are discharged from the eductor 515 through an outlet to caustic feed line 505. Thus, a mixture of water and caustic is provided in the caustic feed line 505. In certain embodiments, the caustic is sodium hydroxide provided in the form of a 25% sodium hydroxide aqueous solution from the caustic source 500.

In certain embodiments, valve 510 is air-actuated. The valve 510 may be operated by the system controller 111. In certain embodiments, valve 510 is a spring valve biased to close. Thus, in the event of a loss of power, valve 510 closes to stop flow of water to eductor 515.

As shown, a shut-off valve 540 may be provided on the caustic input line 503. The shut-off valve 540 may be manually operated.

As further shown, a valve 550 is also provided on the caustic input line 503. In certain embodiments, valve 550 is air-actuated. The valve 550 may be operated by the system controller 111. In certain embodiments, valve 550 is a spring valve biased to close. Thus, in the event of a loss of power, valve 550 closes to stop flow of caustic through the caustic input line 503.

It is noted that the respective flow rates through input lines 303, 403, and 503 to respective eductors 315, 415, and 515, may be controlled by the flow rate of water through the respective valves 310, 410, and 510 and by the flow rate through valves 350, 450, and 550. Thus, controller 111 may control the amount of glyoxal, acid, or caustic added to the tank 900 by controlling the valves 310, 350, 410, 450, 510, and 550.

As a safety precaution, when valve 210 is closed and the supply of water from water source 200 is stopped, no glyoxal may be fed through glyoxal line 305 into tank 900; no acid may be fed through acid line 405, and no caustic may be fed through caustic line 505. Specially, there is motive fluid force of water through eductor 315 to pull glyoxal from glyoxal source 300; there is motive fluid force of water through eductor 415 to pull acid from acid source 400; and there is motive fluid force of water through eductor 515 to pull caustic from caustic source 500. Therefore, when closed, shut-off valve 210 stops the inflow of glyoxal, acid, and/or caustic into tank 900.

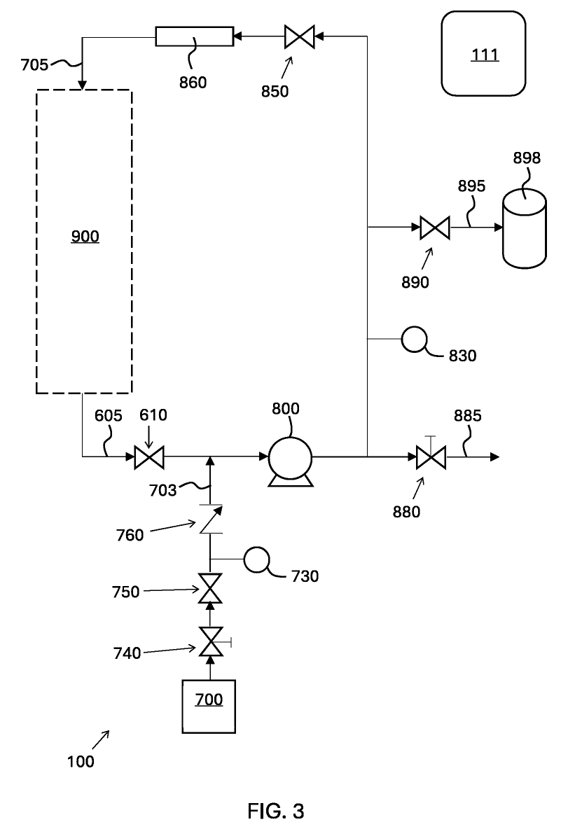

Referring now to FIG. 3, addition of the polyacrylamide to the tank 900 is described. As shown, a polyacrylamide source 700 is provided in fluid communication with a polyacrylamide input line 703. In certain embodiments, the polyacrylamide is cationic polyacrylamide (CPAM) and the polyacrylamide source 700 is a cationic polyacrylamide (CPAM) source 700. Due to the viscosity of the polyacrylamide, the polyacrylamide input line 703 may be larger than the other input lines. For example, the polyacrylamide input line 703 may have a two-inch diameter while the input lines 303, 403, and 503 may have a half-inch diameter, and while the water feed line 205 and feed lines 305, 405, and 505 have one-inch diameters.

As shown, a shut-off valve 740 may be provided on the polyacrylamide input line 303. The shut-off valve 340 may be manually operated.

As further shown, a valve 750 is also provided on the polyacrylamide input line 703. In certain embodiments, valve 750 is air-actuated. The valve 750 may be operated by the system controller 111. In certain embodiments, valve 750 is a spring valve biased to close. Thus, in the event of a loss of power, valve 750 closes to stop flow of polyacrylamide through the polyacrylamide input line 703.

Downstream of the valve 750, a sensor 730 is provided on the polyacrylamide input line 703. Sensor 730 may be a flow meter for monitoring the flow rate of polyacrylamide in polyacrylamide input line 703. Sensor 730 may be in electronic communication with the controller 111, such as by wired or wireless connection.

Also, a check valve 760 may be provided on the polyacrylamide input line 703 to prevent back flow through polyacrylamide input line 703.

In FIG. 3, a pump 800 is in fluid communication with the polyacrylamide input line 703. In certain embodiments, the pump 800 is air-operated, i.e., pneumatic. For example, the pump 800 may be an air-operated diaphragm (AOD) pump.

As shown, upstream of the pump 800, the polyacrylamide input line 703 is in fluid communication with a valve 610. More specifically, valve 610 is located on the product output line 605. When closed, valve 610 prevents flow through the product output line 605 to the pump 800. In certain embodiments, valve 610 is air-actuated. Valve 610 may be operated by the system controller 111. In certain embodiments, valve 610 is a spring valve biased to close. Thus, in the event of a loss of power, valve 610 closes to stop flow of product through the product output line 605.

As shown, downstream of the pump 800, the polyacrylamide input line 703 is in fluid communication with valves 880, 890, and 850.

As shown in FIG. 3, valve 880 is on a drain line 885. In certain embodiments, valve 880 is a shut-off valve 880. The shut-off valve 880 may be manually operated, or in certain embodiments may be controlled by system controller 111. When opened, the shut-off valve 880 allows flow from the pump 800 to the drain line 885.

As further shown, a sensor 830 is located on the feed line 705 downstream of the pump 800. Sensor 830 may be a flow meter for monitoring the flow rate of the fluid in feed line 705 (such as the flow rate of polyacrylamide, or the flow rate of product as described below). Sensor 830 may be in electronic communication with the controller 111, such as by wired or wireless connection.

As further shown in FIG. 3, valve 890 is located on a transfer line 895 to a bulk tank 898. In certain embodiments, valve 890 is air-actuated. Valve 890 may be operated by the system controller 111. In certain embodiments, valve 890 is a spring valve biased to close. Thus, in the event of a loss of power, valve 890 closes to stop flow through the transfer line 895 to the bulk tank 898. When opened, the valve 890 allows flow from the pump 800 through the transfer line 885 to bulk tank 898.

Also shown in FIG. 3, valve 850 is located on the feed line 705. In certain embodiments, valve 850 is air-actuated. Valve 850 may be operated by the system controller 111. In certain embodiments, valve 850 is a spring valve biased to close. Thus, in the event of a loss of power, valve 850 closes to stop flow through the feed line 705 to the tank 900. When opened, the valve 850 allows flow from the pump 800 through the feed line 705 to tank 900.

System 100 may further include a flow device 860 on the feed line 705.

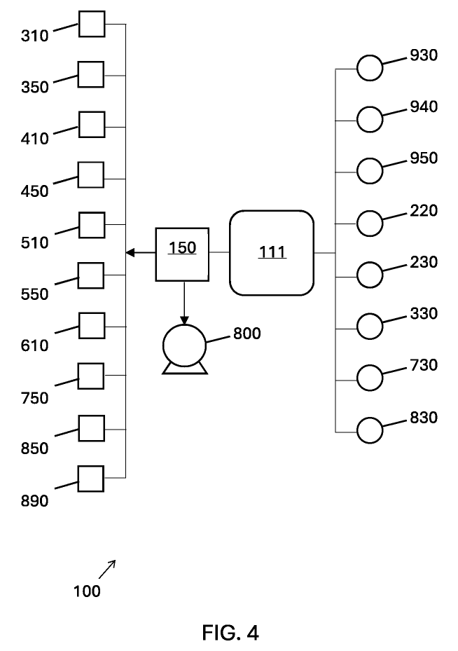

FIG. 4 is a schematic illustrating the electronic and air flow connections of components of system 100. As shown, system 100 includes an air source 150 that may be operatively connected to the controller 111.

In FIG. 4, each sensor 930, 940, 950, 220, 230, 330, 730, and 830 may communicate with controller 111. Specifically, each respective sensor may transmit a data signal indicative of the condition monitored by the respective sensor, i.e., pressure, flow rate, pH, tank level, etc. It is noted that while the individual sensors are illustrated in FIGS. 1-4, the system 100 may include additional sensors, and such sensors may be in communication with the controller 111.

As further shown in FIG. 4, air flow paths are provided between the air source 150 and valves 310, 350, 410, 450, 510, 550, 610, 750, 850, and 890. The controller 111 may direct air from the air source 150 to a selected valve or valves to open the selected valve(s) to let a desired flow of fluid through the respective valve(s). When air is not directed to a respective valve, the valve returns to the closed configuration due to the spring bias.

Also, an air flow path is provided between the air source 150 and the pump 800, e.g., the air-operated diaphragm (AOD) pump 800. Again, the controller 111 may selectively direct air from the air source 150 to the pump 800 to operate the pump 800 with a desire output level.

With the arrangement of components described in FIGS. 1-4, system 100 provides for selective addition of water, glyoxal, acid, caustic, and polyacrylamide to the tank 900, and selective removal of product from the tank 900. Further, product removed from the tank 900 may also be recirculated to the tank.

For example, the system may use the force supplied by the water source 200 to selectively add water and glyoxal, water and acid, or water and caustic to the tank 900. First, shut-off valves 210, 340, 440, 540, and 740 are opened to allow flow, while shut-off valve 880 is closed to stop flow to the drain line 885.

To add water and glyoxal, controller 111 opens valve 310 and closes valves 410 and 510 so that water is directed to the glyoxal eductor 315. Further, controller 111 opens valve 350 to allow a desired flow rate of glyoxal through input line 303. As a result, water and glyoxal are mixed in the eductor 315 and fed to the tank 900 through feed line 305.

To add polyacrylamide, controller 111 closes valves 610 and 890, and opens valve 850. Further, controller 111 opens valve 750 to allow a desired flow rate of polyacrylamide through input line 703. Also, controller 111 activates pump 800 to pump the polyacrylamide through input line 703 and through feed line 705 to tank 900.

The amount of glyoxal, water, and polyacrylamide present in the tank 900 may be calculated from the flow rates measured at sensors 330 and 830. Further, the fluid level in the tank 900 may be measured by sensor 930 and converted to a volume in the tank 900.

When desired amounts of glyoxal, water, and polyacrylamide are present in the tank 900, the reaction to make GPAM may be activated or triggered by increasing the pH in the tank 900 to a threshold. Specifically, caustic is added to the tank 900.

To add water and caustic, controller 111 opens valve 510 and closes valves 310 and 410 so that water is directed to the caustic eductor 515. Further, controller 111 opens valve 550 to allow a desired flow rate of caustic through input line 503. As a result, water and caustic are mixed in the eductor 515 and fed to the tank 900 through feed line 505.

While pH is being increased and during the reaction to form GPAM, the system 100 may provide for recirculating the product mixture from within the tank 900. To recirculate, controller 111 closes valves 750 and 890, and opens valves 610 and 850. Also, controller 111 activates pump 800 to pump the product mixture from the output line 605 to the feed line 705. During recirculation, the sensor 830 monitors the flow rate of the recirculated flow.

Sensors 930, 940, and 950 monitor conditions in the tank 900. During the reaction, the controller 111 may adjust the pH in the tank 900 by adding caustic as described above, or by adding acid.

When the controller 111 determines that the desired turbidity threshold or range is reached by the product mixture, the controller 111 quenches the crosslinking reaction by decreasing the pH of the mixture. Specifically, acid is added through feed line 405.

To add water and acid, controller 111 opens valve 410 and closes valves 310 and 510 so that water is directed to the acid eductor 415. Further, controller 111 opens valve 450 to allow a desired flow rate of acid through input line 403. As a result, water and acid are mixed in the eductor 415 and fed to the tank 900 through feed line 405.

It is noted that flow meters are not necessary to measure the addition of acid and caustic in the tank 900. Rather, monitoring the pH inside the tank 900 is sufficient to determine whether to add acid or caustic.

After quenching the reaction, the product may be removed from the tank 900. To remove the product, controller 111 closes valves 750 and 850, and opens valves 610 and 890. Also, controller 111 activates pump 800 to pump the product from the output line 605 to the product line 895 to bulk tank 898. During recirculation, the sensor 830 monitors the flow rate of the product flow.

When it is desired to empty the tank 900, shut-off valve 880 is opened, the controller closes valves 750, 890, and 850 and opens valve 610. Also, controller 111 activates pump 800 to pump the contents of the tank 900 from the output line 605 to the drain line 885. It is noted that the reaction may form a gel if the pH is improperly controlled or if the reaction is not quenched in a timely manner. The pump 800, designed with relatively short section lines into the pump 800, is capable of pumping actual solid gels. For example, the pump 800 may pull in the gel and break it up into pieces that flow to the drain line 885.

Rather than powering the system 100 with electricity, the system 100 uses the flow pressure or force of the water source 200 and the air source 150 to operate valves, eductors, and the pump. With the described use of water energy input, air-activated valves, and air-activated pump, the system 100 does not require high voltage. Specifically, the system 100 may operate on 120 voltage, with a maximum amperage pull of two to three amps. Thus, maintenance of the system 100 does not require highly trained electricians.

Further, as a vacuum is applied to the hazardous components, such as the acid and caustic, leaks in the system lines result in air entering the lines, rather than hazardous components leaking from the lines.

Also, the system 100 operates without any rotating parts, further reducing workplace hazards.

Setting up the system 100 to make GPAM merely requires interconnecting the system components: the glyoxal source 300, acid source 400, caustic source 500, and polyacrylamide source 700; connecting the system 100 to a water source 200; connecting the system to an air source 150; and connecting the system 100 to a normal 120 V electricity outlet.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A modular on-site production unit for producing glyoxalated polyacrylamide (gPAM) comprising:
an air driven pump configured to provide energy for mixing, adding water, chemicals and transferring a product; and
eductors configured to convey hazardous chemicals using energy provided from water pressure, wherein the hazardous chemicals are conveyed at less than atmospheric pressure, wherein control functions use only 12 to 24 volts direct current (VDC).

2. The production unit of claim 1, wherein the air driven pump is in selective communication with a polyacrylamide source and configured to pump polyacrylamide to a reaction tank in a first mode of operation, to re-circulate contents of the reaction tank in a second mode of operation, and to remove a product including the glyoxalated polyacrylamide (gPAM) from the reaction tank in a third mode of operation.

3. The production unit of claim 1, further comprising:
a reaction tank;
a controller; and
a pH sensor configured to monitor pH within the reaction tank and to communicate a pH signal to the controller;
wherein the controller is configured to determine whether to add caustic to the reaction tank based on the pH.

4. The production unit of claim 1, further comprising:
a reaction tank;
a controller; and
a turbidity sensor configured to monitor a turbidity within the reaction tank and to communicate a turbidity signal to the controller;
wherein the controller is configured to determine whether to add acid to the reaction tank based on the turbidity.

5. The production unit of claim 1, wherein the eductors comprise:
a first water-actuated eductor in selective communication with a water source and a glyoxal source and configured to form a mixture of glyoxal and water and to feed the mixture of glyoxal and water to a reaction tank; and
a second water-actuated eductor in selective communication with the water source and a caustic source and configured to form a mixture of caustic and water and to feed the mixture of caustic and water to the reaction tank to increase a pH therein to a threshold pH at which a crosslinking reaction forms the glyoxalated polyacrylamide (gPAM).

6. The production unit of claim 5, wherein the air driven pump is in selective communication with a polyacrylamide source and configured to pump polyacrylamide to the reaction tank in a first mode of operation, to re-circulate contents of the reaction tank in a second mode of operation, and to remove a product including the glyoxalated polyacrylamide (gPAM) from the reaction tank in a third mode of operation.

7. The production unit of claim 6, further comprising a third water-actuated eductor in selective communication with the water source and an acid source and configured to form a mixture of acid and water and to feed the mixture of acid and water to the reaction tank to decrease the pH therein to quench the crosslinking reaction.

8. The production unit of claim 7, further comprising:
a first air-actuated valve configured to feed glyoxal to the first water-actuated eductor;
a second air-actuated valve configured to feed caustic to the second water-actuated eductor; and
a third air-actuated valve configured to feed acid to the third water-actuated eductor.

9. The production unit of claim 8, further comprising:
a controller;
a pH sensor configured to monitor pH within the reaction tank and to communicate a pH signal to the controller; and
a turbidity sensor configured to monitor a turbidity within the reaction tank and to communicate a turbidity signal to the controller;
wherein the controller is configured to determine whether to add caustic to the reaction tank based on the pH, and to automatically operate the second air-actuated valve to add caustic to the reaction tank, and
wherein the controller is configured to determine whether to add acid to the reaction tank based on the turbidity, and to automatically operate the third air-actuated valve to add acid to the reaction tank.

10. A low voltage system for making glyoxalated polyacrylamide (gPAM), the system comprising:
a reaction tank;
a first water-actuated eductor in selective communication with a water source and a glyoxal source and configured to form a mixture of glyoxal and water and to feed the mixture of glyoxal and water to the reaction tank;
a second water-actuated eductor in selective communication with the water source and a caustic source and configured to form a mixture of caustic and water and to feed the mixture of caustic and water to the reaction tank to increase a pH therein to a threshold pH at which a crosslinking reaction forms glyoxalated polyacrylamide (gPAM); and
an air-operated pump in selective communication with a polyacrylamide source and configured to pump polyacrylamide to the reaction tank in a first mode of operation, to re-circulate contents of the reaction tank in a second mode of operation, and to remove a product including the glyoxalated polyacrylamide (gPAM) from the reaction tank in a third mode of operation.

11. The system of claim 10, wherein the system operates without using a voltage greater than 24 volts.

12. The system of claim 11, further comprising:
a third water-actuated eductor in selective communication with the water source and an acid source and configured to form a mixture of acid and water and to feed the mixture of acid and water to the reaction tank to decrease the pH therein to quench the crosslinking reaction;
a first air-actuated valve configured to feed glyoxal to the first water-actuated eductor;
a second air-actuated valve configured to feed caustic to the second water-actuated eductor;
a third air-actuated valve configured to feed acid to the third water-actuated eductor;
a controller;
a pH sensor configured to monitor pH within the reaction tank and to communicate a pH signal to the controller;
a turbidity sensor configured to monitor a turbidity within the reaction tank and to communicate a turbidity signal to the controller;
a first flow sensor for monitoring a flow rate of glyoxal to the first water-actuated eductor and for communicating a first flow rate signal to the controller;
a second flow sensor for monitoring a flow rate of polyacrylamide to the reaction tank and for communicating a second flow rate signal to the controller,
a drain line;
a fifth air-actuated valve configured to selectively open fluid communication between the drain line and the air-operated pump to empty the reaction tank, wherein the air-operated pump is configured to pump the contents of the reaction tank to the drain line in a fourth mode of operation;
a bulk tank; and
a sixth air-actuated valve configured to selectively open fluid communication between the bulk tank and the air-operated pump to pump the product including glyoxalated polyacrylamide (gPAM) to the bulk tank in the third mode of operation;
wherein the controller is configured to:
determine whether to add caustic to the reaction tank based on the pH, and to automatically operate the second air-actuated valve to add caustic to the reaction tank;
determine whether to add acid to the reaction tank based on the turbidity, and to automatically operate the third air-actuated valve to add acid to the reaction tank;
automatically operate the air-operated pump to pump the polyacrylamide to the reaction tank in the first mode of operation;
automatically operate the air-operated pump to pump to re-circulate the contents of the reaction tank in the second mode of operation;
automatically operate the air-operated pump to remove the product including glyoxalated polyacrylamide (gPAM) from the reaction tank in the third mode of operation;
calculate a quantity of glyoxal fed to the reaction tank based on the first flow rate signal; and
calculate a quantity of polyacrylamide fed to the reaction tank based on the second flow rate signal.

13. A low voltage method for making glyoxalated polyacrylamide (gPAM), the method comprising:
feeding glyoxal and water into a tank;
operating an air-operated pump in a first mode to feed a polyacrylamide to the tank;
feeding caustic into the tank to increase a pH therein to a threshold pH at which a crosslinking reaction forms the glyoxalated polyacrylamide (gPAM);
operating the air-operated pump in a second mode to re-circulate contents of the tank with the air-operated pump; and
after quenching the crosslinking reaction, operating the air-operated pump in a third mode to remove a product including the glyoxalated polyacrylamide (gPAM) from the tank.

14. The method of claim 13, wherein the method is performed without using a voltage greater than 24 volts.

15. The method of claim 14, further comprising forming a mixture of glyoxal and water with a first water-actuated eductor, wherein feeding the glyoxal and water into the tank comprises feeding the mixture of glyoxal and water into the tank.

16. The method of claim 15, further comprising:
forming a mixture of caustic and water with a second water-actuated eductor, wherein feeding the caustic into the tank comprises feeding the mixture of caustic and water into the tank.

17. The method of claim 16, further comprising:
forming a mixture of acid and water with a third water-actuated eductor; and
feeding the mixture of acid and water to the tank to decrease the pH therein to quench the crosslinking reaction.

18. The method of claim 17, further comprising:
operating a first air-actuated valve to feed glyoxal to the first water-actuated eductor;
operating a second air-actuated valve to feed caustic to the second water-actuated eductor; and
operating a third air-actuated valve to feed acid to a third water-actuated eductor.

19. The method of claim 18, further comprising:
monitoring a pH within the tank with a pH sensor;
communicating the pH to a controller;
determining with the controller whether to add caustic to the tank based on the pH; and
automatically operating the second air-actuated valve with the controller to add caustic to the tank.

20. The method of claim 19, further comprising:
monitoring a turbidity within the tank with a turbidity sensor;
communicating the turbidity to the controller;
determining with the controller whether to add acid to the tank based on the turbidity; and
automatically operating the third air-actuated valve with the controller to add acid to the tank.
